(19) United States
(12) Patent Application Publication
(10) Pub. No.: US 2014/0284914 A1
(43) Pub. Date: Sep. 25, 2014

(54) PIPE WELD COATING GUARD

(71) Applicant: Stratos Tsambarlis, Campbell, OH (US)

(72) Inventor: Stratos Tsambarlis, Campbell, OH (US)

(21) Appl. No.: 14/220,269

(22) Filed: Mar. 20, 2014

Related U.S. Application Data
(60) Provisional application No. 61/804,798, filed on Mar. 25, 2013.

(51) Int. Cl. F16L 57/00

(52) U.S. Cl. CPC F16L 57/005
USPC 285/55

(57) ABSTRACT

A pipe shield for providing a portable onsite protection system for weld coating material applied over and extending from a pipe joint weld line on a pipe. The pipe shield is a split sleeve that is positioned and held in annular spaced relation on the pipe protecting the weld coating from extraneous debris and contact during the required cure time.

This application claims the benefit of U.S. Provisional Application No. 61/804,798, filed Mar. 25, 2013.

### BACKGROUND OF THE INVENTION

1. Technical Field

This invention relates to pipe covering devices that are applied to pipe for a variety of applications including pipe insulation, joint connections and the like.

2. Description of Prior Art

Prior art devices of this type have been directed to a number of different pipe application requirements; see for example U.S. Pat. Nos. 3,818,949, 7,716,967, 7,131,671 and U.S. Publications 2004/0237632 and 2007/0240861.

In U.S. Pat. No. 3,818,949 a removable insulation pipe jacket can be seen having two interlocking semi-circular sections, each having a rigid exterior and an inner layer of insulation.

U.S. Pat. No. 7,716,967 discloses a leak protector sleeve that is made of elastomeric material that allows achieving a gas tight seal when a leak detector sleeve encircles a flange joint.

U.S. Pat. No. 7,131,671 is directed towards a transparent coupling in which a transparent coupling for joining ends soft plastic conduit is disclosed. Visual inspection is possible through the coupling to confirm the conduits have been installed in the proper position within the coupling.

U.S. Patent Publication 2004/0237632 discloses a pipe joint safety inspection device having two joint interface elements hinged together adapted to fit over a joint interface so as to form a seal bridging the joint interface therewithin.

U.S. Patent Publication 2007/0240816 claims a protective girth weld cover with air release that shows a heat recoverable polymer material having adhesive coating is positioned over the girth weld wherein air trapped underneath can be released through a plurality of apertures within during the shrinking of the heat recovery polymer material.

### SUMMARY OF THE INVENTION

A portable weld coating protection cover that can be secured on a pipe allowing the applied weld coating to properly cure undisturbed in compliance with safety inspection standards. The pipe cover comprises a hinged split sleeve configuration with resilient end pipe engagement seals to space the pipe cover in relation around the pipe as applied. The pipe cover split sleeve overlaps and is held together by flexible attachment straps. Air circulation within the area defined by the pipe cover via vent opening along the hinged sleeve halves assuring proper curing of the weld coating material. Once the weld coating cure time has been reached, the pipe cover can be easily removed and reused at another location.

### DESCRIPTION OF THE DRAWINGS

FIG. 1 is a perspective view of the pipe shield of the invention fitted over a welded pipe joint.

FIG. 2 is an enlarged end elevational view of the pipe shield in closed non-applied orientation.

FIG. 3 is a side elevational view of the pipe shield.

FIG. 4 is a side elevational view of a welded pipe joint with the pipe shield shown in broken lines positioned thereon.

FIG. 5 is a partial top plan view of the pipe shield closed with restraint strap engaged.

FIG. 6 is a partial top plan view of the pipe shield in open position illustrating vent between hinges.

### DETAILED DESCRIPTION OF THE INVENTION

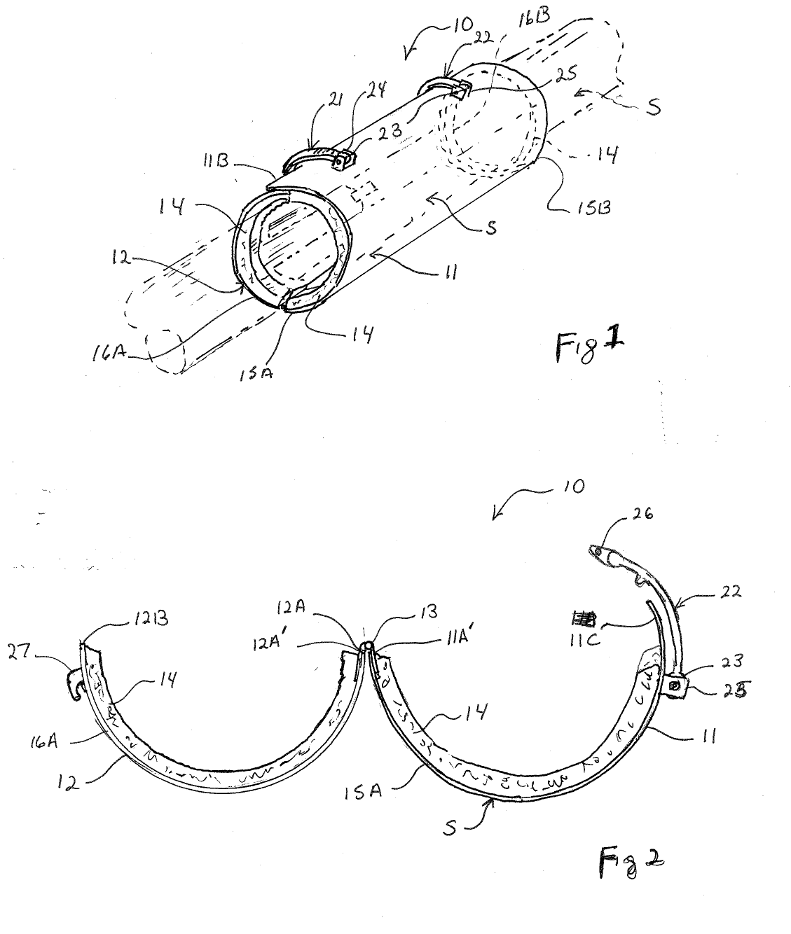

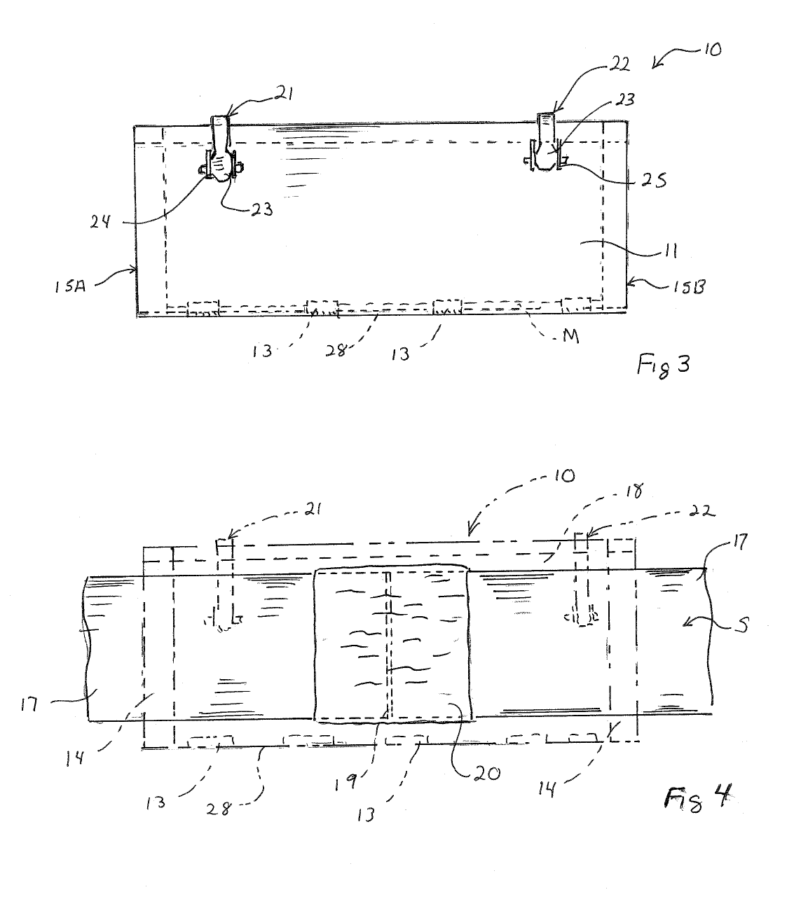

Referring to FIGS. 1-3 of the drawings, a pipe shield 10 of the invention can be seen having a pair of semi-circular elongated split sleeve portions 11 and 12 hinged together along their respective adjacent adjoining longitudinal edges 11A′ and 12A′. Multiple hinge assemblies 13 spaced therealong assure proper engagement and alignment to allow the respective sleeve portions 11 and 12 to be hinged together and joined along the corresponding respective overlapping longitudinal edges 11A, 11B, 12A and 12B as seen in FIGS. 1 and 3 of the drawings.

Each of the respective elongated sleeve portions 11 and 12 have a resilient foam gasket insert 14 extending inwardly from the respective free ends 15A, 15B, 16A and 16B. The respective foam gasket inserts 14 will be engaged on the exterior surface S of a pipe 17 onto which the pipe shield 10 is deployed as seen in FIG. 1 of the drawings and in broken lines in FIG. 4 of the drawings. The so engaged foam gasket inserts 14 effectively seal and space the sleeve portions 11 and 12 in spaced relation to the surface S of the pipe 17 therebetween providing a safe undisturbed area 18 about the pipe 17 which includes a weld line 19 and the applied weld coating material 20 thereover as best seen in FIG. 4 of the drawings.

The sleeve portions 11 and 12 are secured in overlapping relation by an extending sleeve portion 11C along its corresponding respective longitudinal edge.

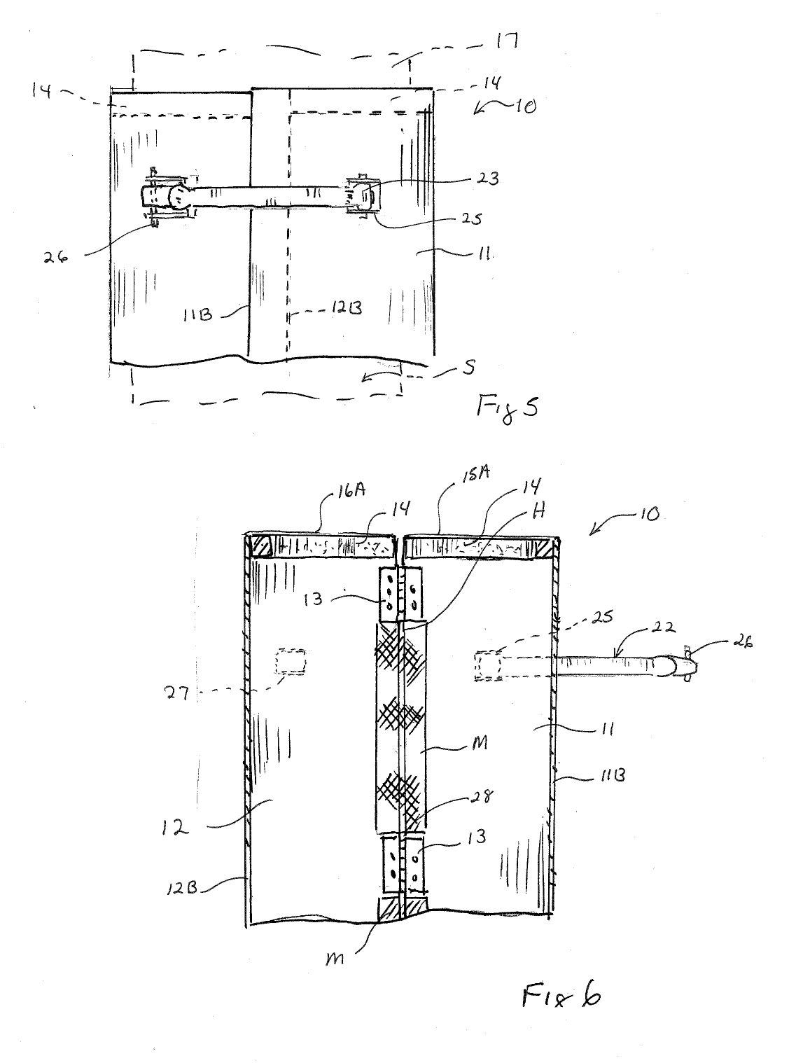

A pair of interlocking strap fittings 21 and 22 are secured to and extend between the outer surfaces of the sleeve portions. Each of the strap fittings 21 and 22 have fixed end 23 pivotally engaged into respective upstanding aperture brackets 24 and 25 respectively on the sleeve surfaces as seen in FIGS. 1, 2 and 3 of the drawings. Each of the strap fittings has an end engagement pin 26 for selective registration within an upstanding catch latch 27 on the adjacent sleeve surface in aligned orientation, best seen in FIG. 5 of the drawings. The primary requirement of the pipe shield 10 is to an effective continuous seal to maintain a form fitting relationship of the foam gaskets 14 on the surface of the pipe 17 and to prevent extraneous debris from coming in contact with and disrupting the field of the weld coating 20 applied over the weld line as hereinbefore described.

The sleeve portions 11 and 12 are preferably made of metal, but may be of any suitable material capable of maintaining the pipe cover 10 applied engagement shaped about the pipe 17 such as synthetic resin molded sheet or so formed material.

In the preferred embodiment a ventilation strip opening 28 is provided between the sleeve portions 11 and 12 along the adjoining hinge line H thereof. The opening 28 between the respecting hinges for ventilation and has a mesh cover M to assure the undisturbed integrity of the weld coating 20 while it cures within the protection of the pipe shield 10.

In use, the pipe shield 10 of the invention is selectively attached to the pipe 17 over the pre-applied weld coating material 20 on a weld joint 19 of the pipe and secured in place by the respective resilient strap fittings 21 and 22 as hereinbefore described.

Once the effective cure time for the weld coating 20 has been reached, the overlapping adaptive edge fitting configuration 11C can be released by releasing the strap fittings and the pipe cover then hinged open and removed for reuse.

It will be evident that by providing different size pipe engagement sealing gaskets 14, a variety of pipe dimensions can be accommodated within a single pipe shield in a given range. It will thus be seen that a new and novel pipe shield 10 has been illustrated and described and it will be apparent to those skilled in the art that various changes and modification may be made therein without departing from the spirit of the invention.

Therefore I claim:

1. A pipe coating shield for protection of welded transmission pipe joints coated with weld protection material comprises,
a split sleeve hinged together along aligned longitudinal adjacent edges,
resilient gasket inserts secured on respective inner sleeve end surfaces,
fastening means on and between said split sleeve free longitudinal edges for selectively securing said split hinge sleeves together around said welded coated pipe joint.

2. The pipe coating shield for protection of welded transmission pipes set forth in claim 1 wherein said resilient gaskets comprise,
expanded synthetic resin foam in a continuous band on oppositely disposed end inner surfaces of said adjacent split sleeve ends defining annular spacers for said adjoining split sleeves.

4. The pipe coating shield for protection of welded transmission pipes set forth in claim 1 wherein said adjoining split sleeves have multiple longitudinally spaced hinges secured along adjacent longitudinal sleeve edges with longitudinal vent edge openings between said split hinges.

5. The pipe coating shield for protection of welded transmission pipe joints set forth in claim 1 wherein said fastener means comprises,
a pair of resilient retainment attachment straps pivotally secured to one of said split sleeves and securely retained on said remaining split sleeve in aligned orientation therewith.

6. The pipe coating shield for protection of welded transmission pipe joints set forth in claim 1 wherein said hinged split sleeves may be made of light gauge metal.

7. The pipe coating shield for protection of welded transmission pipe joints set forth in claim 5 wherein said resilient retainment attachment straps comprises,
an attached pivot engagement end, and a selective retainment end having a pin extending therefrom for selective registration in an open end engagement latch secured on said adjacent split sleeve exterior surface in transverse alignment with said attached pivot engagement.
